(19) United States
(12) Patent Application Publication
(10) Pub. No.: US 2024/0119801 A1
(43) Pub. Date: Apr. 11, 2024

(54) GAMING MACHINE, METHOD OF PROVIDING GAME, AND PROGRAM

(71) Applicant: Konami Gaming, Inc., Las Vegas, NV (US)

(72) Inventor: Masaya MATSUDA, Zama-shi (JP)

(21) Appl. No.: 18/377,182

(22) Filed: Oct. 5, 2023

(30) Foreign Application Priority Data
Oct. 7, 2022 (JP) 2022-162244

(51) Int. Cl. G07F 17/32

(52) U.S. Cl. CPC G07F 17/3267; G07F 17/3213; G07F 17/3244

(57) ABSTRACT

A gaming machine includes an operation unit, a display unit configured to partially display a plurality of reels each having a series of symbols including credit symbols, the credit symbols being associated with predetermined credit values, and a control unit, wherein the control unit includes a processor programmed to spin and stop the plurality of reels; and provide an award based on symbol arrangements, wherein the processor is further programmed to remove all specific symbols from the display unit after stopping the plurality of reels to display the plurality of symbols on the display unit; move subsequent symbols following the removed symbols with respect to a spin direction of the reel to fill positions of the removed symbols, and provide the award based on the credit value associated with the credit symbols displayed on the display unit after moving the subsequent symbols.

### CROSS-REFERENCE TO RELATED APPLICATIONS

This application claims the benefit of priority from Japanese Patent Application No. 2022-162244, filed on Oct. 7, 2022, the entire contents of which are incorporated herein by reference.

### TECHNICAL FIELD

The present disclosure relates to a gaming machine, a method of providing a game, and a program.

### BACKGROUND ART

U.S. Pat. No. 7,887,407 discloses an update process of symbol arrangements in which symbols constituting a winning combination are removed from the symbol arrangements and new symbol arrangements are formed. According to such update processing of symbol arrangements, a player can continue to hold expectations for winning even after the reel is stopped, and the player's interest in the game result is maintained for a long time.

### SUMMARY

As described in U.S. Pat. No. 7,887,407, in a gaming machine in which the update process of symbol arrangements is adopted, symbols constituting a winning combination are removed from the symbol arrangements, and thus the types of symbols left without constituting a winning combination are only averagely distributed. In particular, only symbols having low ranks may remain when symbols having high ranks constitute a winning combination. Due to such circumstances, the player may not have great expectations for new symbol arrangements formed after symbols are removed, and the player's interest in the game result may be reduced. Therefore, an update process of symbol arrangements that can maintain and/or improve the player's interest even after symbols have been removed is expected.

An object of the present disclosure is to provide a gaming machine, a method of providing a game, and a program capable of providing a new game that maintains or improves the player's interest.

A gaming machine according to one aspect of the present disclosure includes: an operation unit configured to receive an operation of a player; a display unit configured to partially display a plurality of reels each having a series of symbols including credit symbols, the credit symbols being associated with predetermined credit values; and a control unit connected to the operation unit and the display unit, the control unit including a processor programmed to: spin and stop the plurality of reels in response to operating the operation unit by the player; and provide an award based on symbol arrangements formed on the display unit by the stopped plurality of reels, wherein the processor is further programmed to: remove all specific symbols from the display unit after stopping the plurality of reels to display the plurality of symbols on the display unit; move subsequent symbols following the removed symbols with respect to a spin direction of the reel to fill positions of the removed symbols; and provide the award based on the credit value associated with the credit symbols displayed on the display unit after moving the subsequent symbols.

A method of providing a game on a gaming machine according to another aspect of the present disclosure, the gaming machine including an operation unit configured to receive an operation of a player, a display unit configured to partially display a plurality of reels each having a series of symbols including credit symbols, the credit symbols being associated with predetermined credit values, and a control unit connected to the operation unit and the display unit, wherein the control unit includes a processor programmed to spin and stop the plurality of reels in response to the operation of the operation unit by the player and provide an award based on symbol arrangements formed on the display unit by the stopped plurality of reels, the method includes: spinning the plurality of reels in response to a player's operation of the operation unit; stopping rotation of the plurality of reels and displaying a plurality of symbols on the display unit; removing all specific symbols from the display unit; moving subsequent symbols following the removed symbols with respect to a spin direction of the reel to fill positions of the removed symbols; and providing an award based on the credit value associated with the credit symbols displayed on the display unit after moving the subsequent symbols.

A non-transitory computer-readable storage medium storing a program to be executed by a computer according to still another aspect of the present disclosure, the computer including an operation unit configured to receive an operation of a player, a display unit configured to partially display a plurality of reels each having a series of symbols including credit symbols, the credit symbols being associated with predetermined credit values, and a control unit connected to the operation unit and the display unit, wherein the control unit includes a processor programmed to spin and stop the plurality of reels in response to the operation of the operation unit by the player and provide an award based on symbol arrangements formed on the display unit by the stopped plurality of reels, the program causes the processor to: spin the plurality of reels in response to a player's operation of the operation unit; stop rotation of the plurality of reels and displaying a plurality of symbols on the display unit; remove all specific symbols from the display unit; move subsequent symbols following the removed symbols with respect to a spin direction of the reel to fill positions of the removed symbols; and provide an award based on the credit value associated with the credit symbols displayed on the display unit after moving the subsequent symbols.

According to the present disclosure, it is possible to provide a gaming machine, a method of providing a game, and a program capable of providing a new game that maintains and/or improves a player's interest.

### BRIEF DESCRIPTION OF DRAWINGS

FIG. 1 is a perspective view illustrating an example of a gaming machine according to an embodiment.

FIG. 2 is a block diagram illustrating an example of a configuration of the gaming machine in FIG. 1.

FIG. 3 is a diagrammatic illustration of a display area of the gaming machine in FIG. 1.

FIG. 4A is a figure showing an example of a virtual reel set.

FIG. 4B is a figure showing an example of a virtual reel set.

FIG. 5 is a figure showing an example of a symbol.

FIG. 6 is a figure showing one state of symbol arrangements in an update process of symbol arrangements.

FIG. 7 is a figure showing one state of symbol arrangements in an update process of symbol arrangements.

FIG. 8 is a figure showing one state of symbol arrangements in an update process of symbol arrangements.

FIG. 9 is a figure showing one state of symbol arrangements in an update process of symbol arrangements.

FIG. 10 is a figure showing one state of symbol arrangements in an update process of symbol arrangements.

FIG. 11 is a figure showing one state of symbol arrangements in an update process of symbol arrangements.

FIG. 12 is a figure showing one state of symbol arrangements in an update process of symbol arrangements.

FIG. 13 is a figure showing one state of symbol arrangements in an update process of symbol arrangements.

FIG. 14 is a figure showing one state of symbol arrangements in an update process of symbol arrangements.

FIG. 15 is a figure showing one state of symbol arrangements in an update process of symbol arrangements.

FIG. 16 is a figure showing one state of symbol arrangements in an update process of symbol arrangements.

FIG. 17 is a figure showing expansion of a display area of a gaming machine.

FIG. 18 is a directory configuration diagram and a block diagram showing a program and a data stored in the memory in FIG. 2.

FIG. 19 is a block diagram of a system for a gaming machine.

FIG. 20 is a block diagram of the game application program in FIG. 19.

FIG. 21 is a block diagram of the system application program in FIG. 19.

FIG. 22 is a flowchart illustrating an operation of a gaming machine.

FIG. 23 is a flowchart illustrating an operation of a gaming machine.

### DESCRIPTION OF EMBODIMENTS

Hereinafter, a gaming machine according to an embodiment will be described with reference to the accompanying drawings. In the drawings, the same or corresponding portions are denoted by the same reference numerals, and redundant description is omitted.

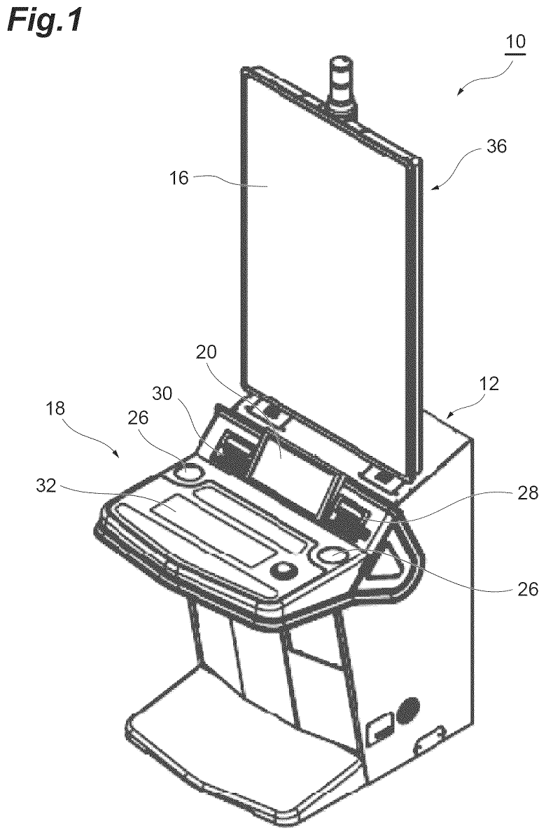

FIG. 1 is a perspective view illustrating an example of a gaming machine according to an embodiment. Here, the gaming machine is a device that receives a wager such as a cash, a medal, or a token from a player, starts a game, and pays a prize, an award, or a payout to the player according to a randomly determined game result. Such a gaming machine is designed and manufactured in accordance with local regulations, and is installed as a device in a licensed facility such as a casino after obtaining authorization by an authorization agency. A gaming machine 10 shown in FIG. 1 may receive a predetermined game value from the player, generate a game result, and provide a payout to the player in response to the game result and a pay table. The gaming machine 10 provides a video slot game as an example. The video slot game includes, for example, a normal game, a free game, and a feature game. The normal game, the free game, and the feature game are provided when a predetermined condition is satisfied. In the normal game, the free game, and the feature game, symbols displayed in the display area constitute a combination of symbols as a game result, and a winning is determined by the combination.

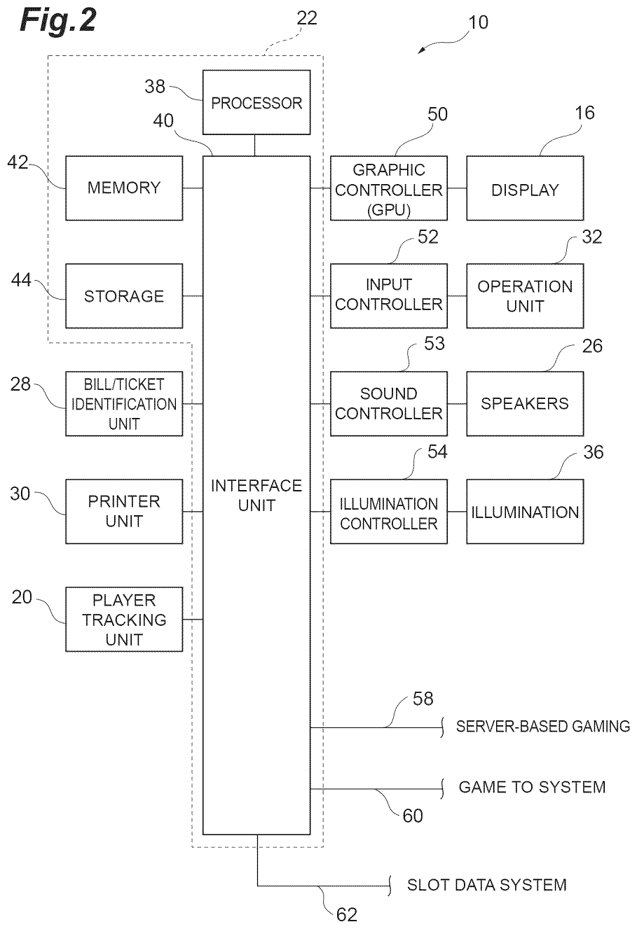

As shown in FIG. 1, the gaming machine 10 includes a display 16 (an example of a display unit) and a cabinet 12. The cabinet 12 also houses a control unit 22 (see FIG. 2) for controlling the components of the gaming machine 10.

The display 16 is a flat panel display device such as a liquid crystal display device or an organic EL display device. The display 16 is controlled via the control unit 22 to provide a game screen to the player. An illumination 36 may be provided around the display 16 to provide decorative lighting.

The cabinet 12 is disposed below the display 16. A control panel 18 is provided on the front surface of the cabinet 12 so as to project forward. The control panel 18 is provided with a player tracking unit 20, speakers 26, a bill/ticket identification unit 28, a printer unit 30, and an operation unit 32.

The player tracking unit 20 includes a card reader for recognizing a player identification card, a display for presenting a data to the player, and a keypad for receiving input by the player. The player tracking unit 20 cooperates with the control unit 22 or an external system to read information recorded on the player identification card inserted into the card reader by the player and display the information and/or information acquired by communicating with the external system on a display. Furthermore, input from the player is received by the keypad, the display is changed according to the input, and communication with an external system is performed as necessary.

The speakers 26 are provided on the left and right of the control panel 18. The speakers 26 are controlled via the control unit 22 to provide sound to the player.

The bill/ticket identification unit 28 may be housed in the cabinet 12 with the insertion opening exposed through which the bill/ticket is inserted. An identification part for identifying bill/ticket by various sensors is provided inside the insertion port. A bill/ticket storage part is provided on the output side of the identification part. The bill/ticket identification unit 28 accepts bill/tickets (including vouchers and coupons) that are the gaming value, identifies them as the gaming value, and notifies the control unit 22.

The printer unit 30 may be accommodated in the cabinet 12 in a state where a ticket output port through which the ticket is output is exposed. A printing part for printing predetermined information on a printing paper is provided inside the ticket output port, and a housing part for housing the printing paper is provided on the paper inlet side of the printing part. The printer unit 30, under control of the control unit 22, prints information on paper and outputs a ticket from the gaming machine 10 according to credit payout processing. The output ticket may be inserted into the bill/ticket identification unit 28 of another gaming machine to use the payout credit for game play, or may be exchange for cash by a kiosk terminal inside of the casino or casino cage.

The operation unit 32 receives an operation of the player. The operation unit 32 includes a group of buttons for receiving various instructions from the player on the gaming machine 10. The operation unit 32, for example, may include a group of spin buttons and setting buttons. The spin button receives an instruction to start an instance of a game (start rotation of reel). The group of setting buttons includes a group of line-designation buttons, a group of bet buttons, a cash-out button and the like. The group of bet buttons receives an instruction operation related to a credit amount of a bet (bet amount) from a player. The cash-out button receives an instruction operation for instructing payout of credit accumulated in the gaming machine 10.

FIG. 2 is a block diagram illustrating an example of the configuration of a gaming machine. The gaming machine 10 includes the control unit 22. The control unit 22 includes a central processing unit (CPU) 38 including a processor constituting the control unit 22, an interface unit 40, a memory 42, a storage 44, and the like. The control unit 22 may be housed inside the cabinet 12 as a control board. The control unit 22 is configured to be able to communicate with each unit via the interface unit 40, and controls the operation of each unit by executing a program recorded in the memory 42 (an example of a storage unit) and/or the storage 44 (an example of a storage unit) of CPU 38 to provide a game to the player.

The interface unit 40 includes a chipset that provides communication functions of CPU 38, such as a memory bus connected to the CPU 38, various expansion buses, a serial interface, a universal serial bus (USB) interface, an Ethernet interface (registered trademark) and the like.

The memory 42 may include a random-access memory (RAM) that is a volatile storage medium, a read only memory (ROM) that is a nonvolatile storage medium, and an electrically erasable programmable read-only memory (EEPROM) that is a rewritable nonvolatile storage medium. The storage 44 provides the control unit 22 with a function as an external storage device, and can use a reading device such as a memory card and a magneto-optical disk which are removable storage media, and can also use a hard disk.

The bill/ticket identification unit 28, the printer unit 30, a player tracking unit 20, a graphic controller (GPU: Graphics Processing Unit) 50, an input controller 52, a sound controller 53, and an illumination controller 54 are connected to the interface unit 40. The graphic controller 50, the input controller 52, the sound controller 53, and the illumination controller 54 may be housed inside cabinet 12 as control boards.

The control unit 22 is connected to the display 16 via the graphic controller 50. The control unit 22 is connected to the operation unit 32 via the input controller 52. The control unit 22 is connected to the illumination 36 via the illumination controller 54.

The control unit 22 controls each unit by executing programs stored in the memory 42 and the storage 44, and provides the game to the player. Here, for example, the program and data of the operating system and subsystem providing basic functions of the control unit 22 may be stored in the EEPROM of the memory 42, and the program and data of the application providing the game may be stored in the storage 44. According to such a configuration, the game can be easily changed or updated by exchanging the storage 44. Furthermore, the control unit 22 may have a multiprocessor configuration including a plurality of CPUs.

Hereinafter, each block connected to the control unit 22 will be described. The bill/ticket identification unit 28 accepts the bill/ticket at the insertion port and notifies the control unit 22 of identification information corresponding to the assortment of bills or payout processing of credit. The control unit 22 increases the credit amount usable in the game according to the notified contents. The printer unit 30 prints information corresponding to payout processing of credit from the gaming machine 10 on a ticket and output under the control of the control unit 22 which receives the operation of a cash-out button included in the operation unit 32.

The player tracking unit 20 cooperates with the control unit 22 to transmit and receive player information and the like to and from the casino management system. The graphic controller 50 controls the display 16 under control of the control unit 22 to display a display image including various graphics data. The sound controller 53 drives the speakers 26 under the control of the control unit 22 to provide various sounds such as announcements, sound effects, BGM and the like. The illumination controller 54 performs lighting control of the illumination 36 under the control of the control unit 22.

The interface unit 40 includes various communication interfaces for communicating with the exterior of the gaming machine 10. The interface unit 40 may communicate with external networks by Ethernet 58, 60 and a serial interface 62, as examples. FIG. 2 shows an example of communication with other the gaming machine 10, a known server-side gaming network (Server-Based gaming), a G2S network (Game to system), and a slot information system (Slot Data System).

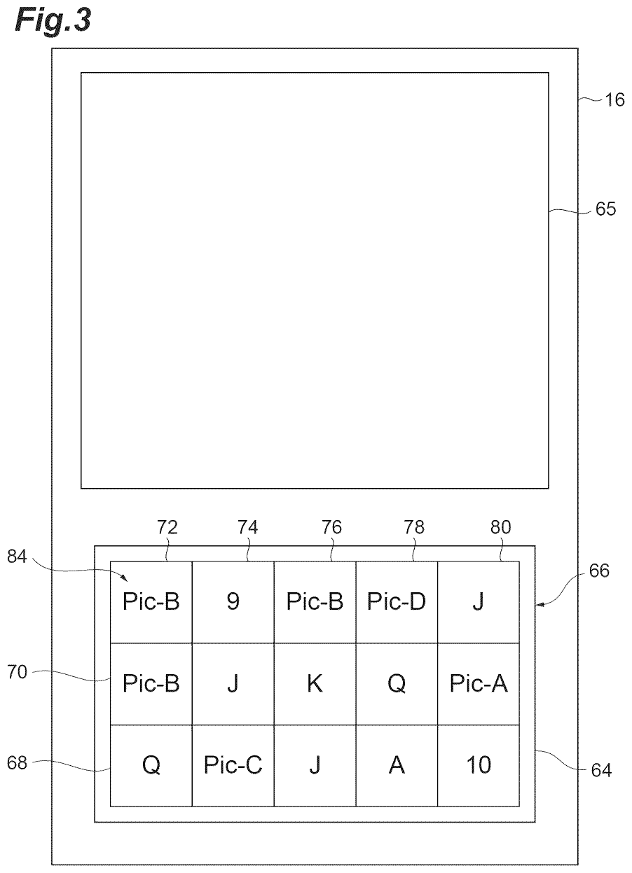

FIG. 3 is a diagrammatic illustration of a display area of the gaming machine in FIG. 1. As shown in FIG. 3, a game screen having a symbol display area 64 for displaying a slot game is displayed on the display 16 by the control unit 22 executing a predetermined program. The symbol display area 64 is displayed in an area below the game screen as an example. An area 65 on which information related to the game is displayed are prepared above the symbol display area 64.

The symbol display area 64 includes a grid 68 capable of displaying symbols. By using such a display area, the gaming machine 10 operates as a slot machine that performs a winning determination according to a combination of symbols displayed on the grid 68 in the symbol display area 64 and provides a payout.

The display 16 displays a plurality of symbols in the grid 68. The grid 68 includes a plurality of rows and columns. The grid 68 is constituted by a plurality of a cell 70 which are stop positions of symbols. FIG. 3 illustrates a game screen including a plurality of cells arranged in a 5×3 grid pattern. The number of columns and the number of rows of the grid are not particularly limited, and may be another configuration such as 5×4, 3-4-4-4-3, 6×3, 6×4, or 3-3-3-5-5, or may be a configuration that increases or decreases according to the game development and/or the bet amount. One symbol is stopped and displayed on each of a plurality of the cell 70 in the symbol display area 64.

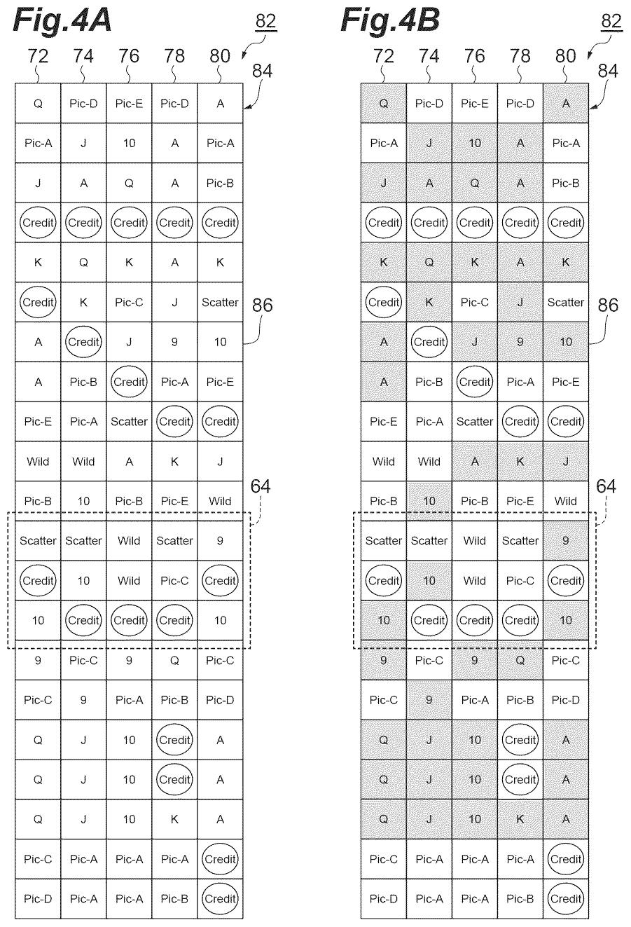

The symbol arranged in each of the plurality of cells 70 is determined by using a virtual reel strip for displaying a virtual reel 66. FIGS. 4A and 4B are figures showing a virtual reel set employed in a normal game and a free game. The virtual reel set includes a plurality of virtual reel strips, and the virtual reel strip includes symbol arrangements indicating the order of symbols displayed in the display area. As shown in FIG. 4A, on each the cells 70 of the grid 68, symbols are displayed based on symbol arrangements of the virtual reel 66 including a virtual reel strips 72, 74, 76, 78, and 80 which form a virtual reel set 82. That is, the cells 70 of the grid 68 correspond to the virtual reel strips 72 to 80 by column, and the symbols arranged in predetermined parts of each virtual reel strips 72 to 80 are displayed. Furthermore, by moving (scrolling or spinning) each symbol by column based on the symbol arrangement of the virtual reel strips 72 to 80, the symbols displayed in the cells 70 of the grid 68 change, and by stopping the movement (scrolling or spinning) by columns, the symbols are stopped. Here, the virtual reel strips 72 to 80 are data where the control unit 22 uses a program having the memory 42 or the storage 44, and data showing the symbol arrangement (i.e., the order of symbols on each reel) regulated by each cell column. The virtual reel set 82 is a general term for such virtual reel strips 72 to 80.

The virtual reel strips 72 to 80 illustrated in FIG. 4A are constituted by symbols in each symbol position 86, and these symbols are arranged in an order defined for each reel. The number of symbols forming the virtual reel strips 72 to 80 is not limited thereto, and may be a desired number. The number of symbols forming the virtual reel strips 72 to 80 may be the same or may be different from each other.

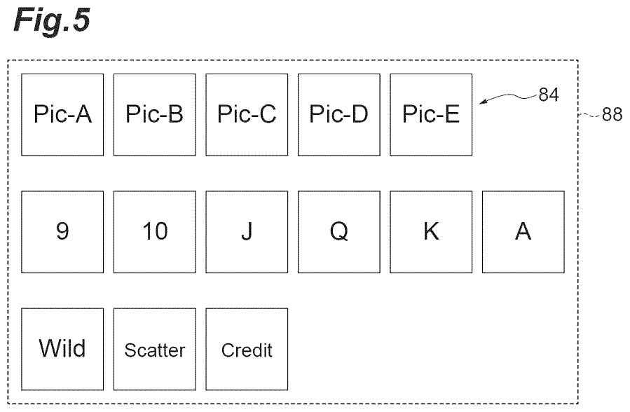

FIG. 5 is a detail of the symbols 84 shown in FIG. 4A. Each of the virtual reel strips 72 to 80 includes symbols selected from a symbol set 88 of various the symbol 84 shown in FIG. 5. The symbol set 88 includes card symbols (“9”, “10”, “J”, “Q”, “K”, and “A”) imitating playing cards as regular symbols, and picture symbols (“Pic-A”, “Pic-B”, “Pic-C”, “Pic-D”, and “Pic-E”) indicating a pattern.

The symbol set 88 includes a wild symbol (“Wild”) that is substituted as another symbol when a winning combination is determined, a scatter symbol (“Scatter”) that triggers a free game in response to the appearance of a predetermined number of symbols when a winning combination is determined, and a credit symbol (“Credit”) to which a predetermined credit value is provided at the time of winning. Since the credit symbol urges the player to directly understand the credit that can be acquired and to directly understand the chance by the appearance of the credit symbol with which the high credit is associated, the player's interest can be maintained or improved. The credit symbol can be, for example, a predetermined picture symbol such as coin on which the associated credit amount is displayed. Furthermore, the credit amount may not be displayed on the credit symbol while the symbol is changed, and the credit amount may be displayed after the symbol is stopped, or the credit amount may be displayed when winning occurs after the symbol is stopped.

A plurality of virtual reel sets may be prepared according to the game content. For example, the virtual reel set used in the normal game may be different from the virtual reel set used in the free game. The virtual reel set in the free game may include more picture symbols or wild symbols than the virtual reel set in the normal game. It is possible to increase the winning probability during the free game, and it is possible to provide the player with a valuable free game.

FIG. 4B is a figure showing a virtual reel set employed in a feature game. The virtual reel set shown in FIG. 4B is different from the virtual reel set shown in FIG. 4A in that it includes symbols removed after the symbols are stopped and displayed, and is the same in other respects. As will be described later, in the feature game, picture symbols, wild symbols, and scatter symbols are removed after the symbols are stopped and displayed. The card symbols displayed in gray does not contribute to award although it is not removed after the symbols are stopped and displayed. In the feature game, award is provided based on the credit values associated with the credit symbols that are stopped and displayed. Hereinafter, symbols that are removed after being stopped and displayed are also referred to as specific symbols. The specific symbols may be a predetermined symbol such as “Pic-A” or “Pic-B”, or may be specific types of symbols such as a picture symbol or a card symbol.

The control unit 22 starts the game and randomly determines the stopping position of each of the virtual reel strips 72 to 80. The virtual reel strips 72 to 80 displayed on the display 16 moves (scrolls or spins) from the current position and stops based on the stopping position to represent the game result. Therefore, in the display 16 or the grid 68, the symbols included in the virtual reel strips 72 to 80 fluctuate in accordance with continuous movement (scrolling or spinning) of the virtual reel strips 72 to 80 in the vertical direction of the symbol display area 64, and are displayed such that one symbol is stopped in one cell 70 according to the order of the symbols defined in the virtual reel strips 72 to 80.

The control unit 22 may be configured to change a plurality of symbols displayed on the display 16 by the above-described method in accordance with the operation of the player received by the operation unit 32, stop the symbols in a predetermined order, and provide a payout in accordance with the symbols stopped in the symbol display area 64.

Pay lines are set for the symbol display area 64. For example, pay line is set so as to extend from cell in the leftmost column to the rightmost column. An example of the pay line can be composed of any cell in the leftmost column, any cell in the second column from the left, any cell in the third column from the left, any cell in the fourth column from the left, and any cell in the fifth column from the left (rightmost column). In the 5×3 matrix, 243 (3 to the 5th power) types of pay lines can be set, however, 40 types or 50 types of pay lines may be set. Such a pay line is activated by being selected by the player, and becomes a winning line. The winning line is a line for determining winning by combining a plurality of the cells 70. The number of winning lines can be selected by operating a group of line-designation buttons included in a group of setting buttons of the operation unit 32 for a player. Alternatively, all of the set pay lines may be set as winning lines regardless of the player's selection. With respect to the game result which is a combination of symbols, the control unit 22 determines winning when the same symbols are aligned on a winning line in excess of a predetermined number, and provides a payout to the player in accordance with the type and number of symbols.

The gaming machine 10 according to the present embodiment provides three kinds of game, for example, normal game (also referred to as a main game or a prime game) provided when a predetermined condition is not satisfied, and first and second special games provided when the predetermined condition is satisfied. The first special game is a feature game, and a feature function advantageous to the player, which will be described later, is applied when a predetermined trigger condition is satisfied. The second special game is a free game, and a predetermined number of times of free games not consuming a game value are provided when a predetermined trigger condition is satisfied.

In the normal game, the first special game, and the second special game, symbols displayed in the symbol display area 64 among symbol arrangements being game results are subject to winning determination. That is, the control unit 22 that has started the game randomly determines a stopping position for each of the virtual reel strips 72 to 80 shown in FIG. 4A or 4B, and expresses an operation in which the virtual reel strips 72 to 80 moves from the current position and stops at the stopping position using the display 16. Accordingly, in the symbol display area 64, the symbols arranged on the virtual reel strips 72 to 80 continuously move (scroll) in the vertical direction, and stop so that one symbol is displayed on one the cell 70 while maintaining continuity.

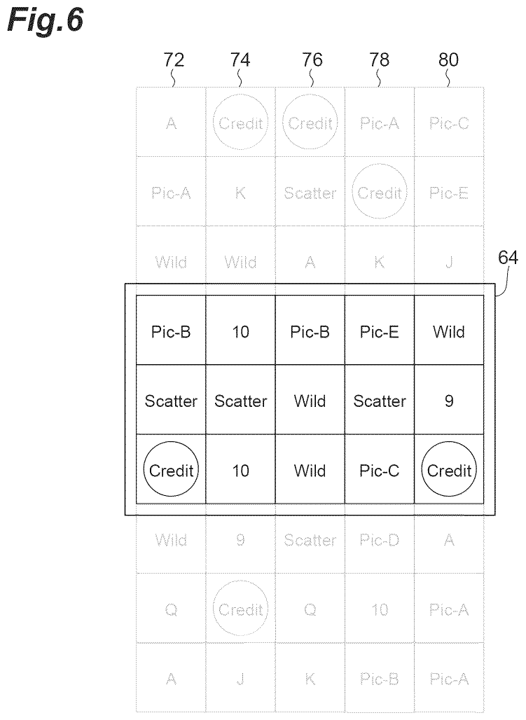

However, in the present embodiment, at the time of the feature game, the feature function described below is applied, and as a result, the symbol arrangements once displayed in the symbol display area 64 are updated to different symbol arrangements. Hereinafter, an update process of symbol arrangements applied in the feature game will be described with reference to FIGS. 6 to 16.

As an example, a case where the control unit 22 spins and stops the virtual reel strips 72 to 80 and displays symbol arrangements shown in FIG. 6 on the symbol display area 64 of the display 16 will be described. First, it is assumed that the trigger condition of the feature game is satisfied. The trigger condition of the feature game is, for example, a case where symbol arrangements displayed in the normal game or the free game include one or more credit symbols and a random number acquired at the start of the game is within a predetermined range.

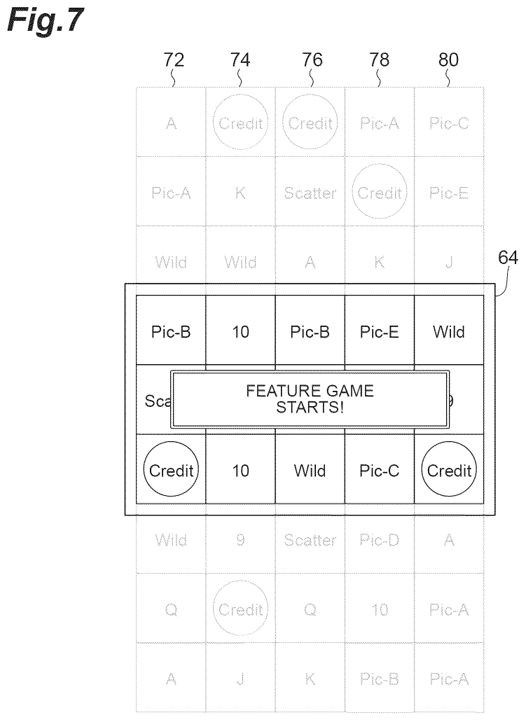

When the trigger condition for the feature game is satisfied, the control unit 22 causes the display 16 to display a message notifying the player of the start of the feature game (see FIG. 7), and starts the feature game. Then, the control unit 22 removes all of the picture symbols, the wild symbols, and the scatter symbols as specific symbols among the symbols displayed on the symbol display area 64 of the display 16. To be more specific, the control unit 22 removes the picture symbol “Pic-B” in upper row regarding the virtual reel strip 72, the scatter symbol “Scatter” in middle row regarding the virtual reel strip 74, the picture symbol “Pic-B” in upper row regarding the virtual reel strip 76, the wild symbols “Wild” in middle and lower rows regarding the virtual reel strip 76, the picture symbols “Pic-E” and “Pic-C” in upper and lower rows regarding the virtual reel strip 78, the scatter symbol “Scatter” in middle row regarding the virtual reel strip 78, and the wild symbol “Wild” in upper row regarding the virtual reel strip 80.

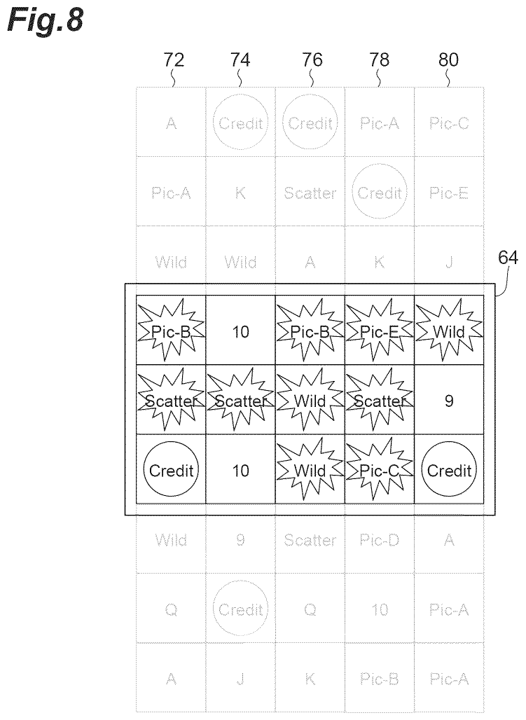

Before removing the specific symbols, the control unit 22 may add target marks to the specific symbols to notify the player of the removal of the symbols. In addition, as shown in FIG. 8, the control unit 22 may display an animation in which the symbol with the target marks are destroyed by a gunshot, so that the player can easily understand that the removed symbols are invalidated. When the control unit 22 removes the card symbols, the cell in which the card symbols had been displayed becomes blank cells in which no symbol is displayed.

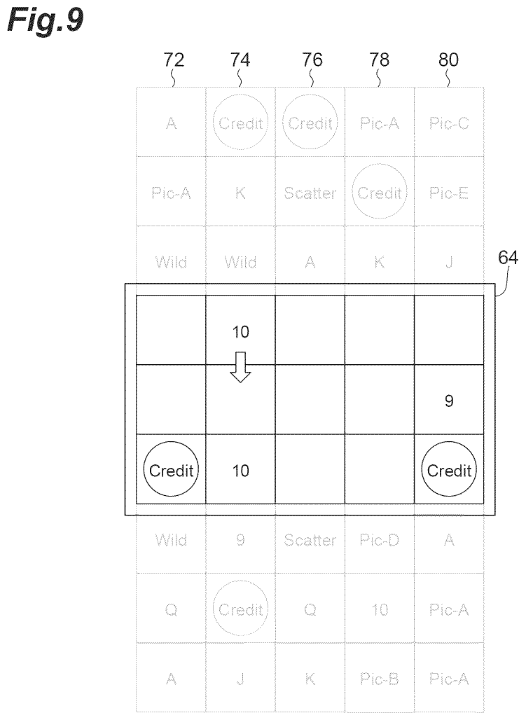

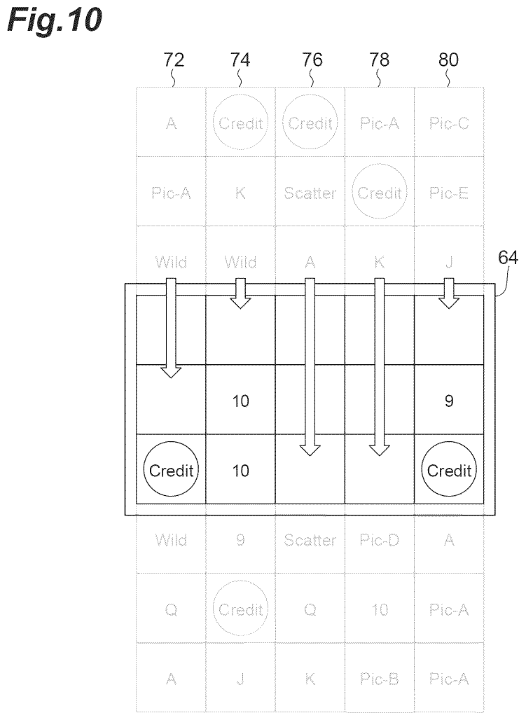

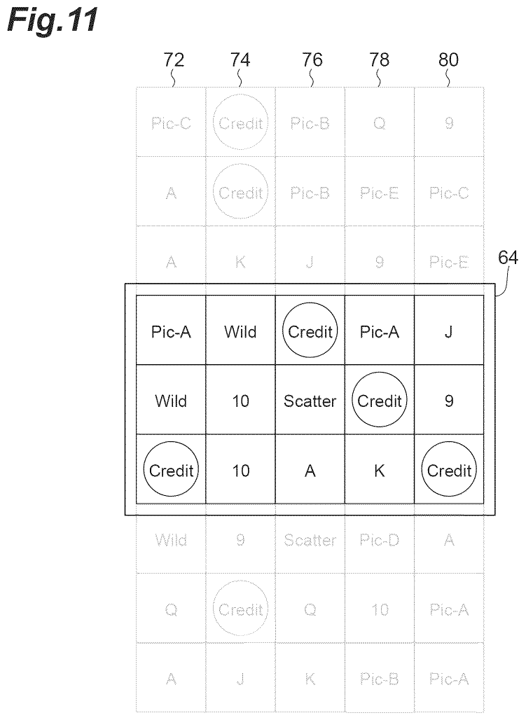

The control unit 22 then fills the blank cells with subsequent symbols following the removed specific symbols. More specifically, the subsequent symbols are symbols displayed on the symbol display area 64 subsequent to the removed card symbols during rotation of the virtual reel strip, and are symbols positioned above the removed specific symbols in FIGS. 4B and 8. As shown in FIGS. 9 and 10, the control unit 22 fills the blank cells by moving the subsequent symbols downward. FIG. 9 shows a state in which the subsequent symbols displayed on the symbol display area 64 move downward. FIG. 10 shows a state in which subsequent symbols outside the area that are not displayed in the symbol display area 64 move into the area. The control unit 22 fills all blank cells as shown in FIG. 11 by moving subsequent symbols to display symbols in all cells the symbol display area 64 of the display 16.

In the present embodiment, the control unit 22 pays out the total amount of displayed credit symbols when the credit symbols are newly displayed as a result of performing the update processing of the symbol arrangements described above (i.e., removing specific symbols and moving subsequent symbols). For example, in FIG. 11, by updating the symbol arrangements shown in FIG. 7, new credit symbols are displayed in the upper row of a reel 76 and the middle row of a reel 78, so that the total amount of displayed credit symbols is paid out. Then, the control unit 22 repeats the update processing of the symbol arrangements described above until no specific symbols newly occur in the symbol display area 64 of the display 16.

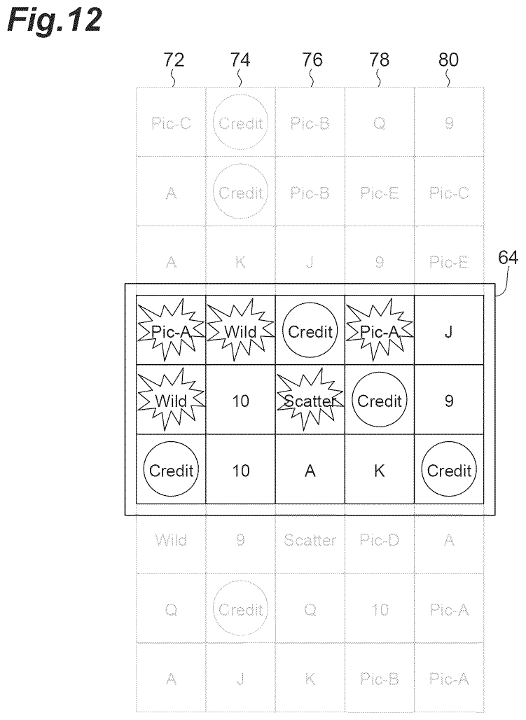

For example, in FIG. 11, after the update processing of symbol arrangements, picture symbol “Pic-A” in the upper row regarding the virtual reel strip 72, wild symbol “Wild” in the middle row regarding the virtual reel strip 72, wild symbol “Wild” regarding the upper row of the virtual reel strip 74, scatter symbol “Scatter” in the middle row regarding the virtual reel strip 76, and picture symbol “Pic-A” in the upper row regarding the virtual reel strip 78 are still present as specific symbols. For this reason, the control unit 22 further repeats the update process to remove those specific symbols. That is, as shown in FIG. 12, in the control unit 22, the specific symbols are removed, and the cells at the positions where the specific symbols are displayed are made blank cells.

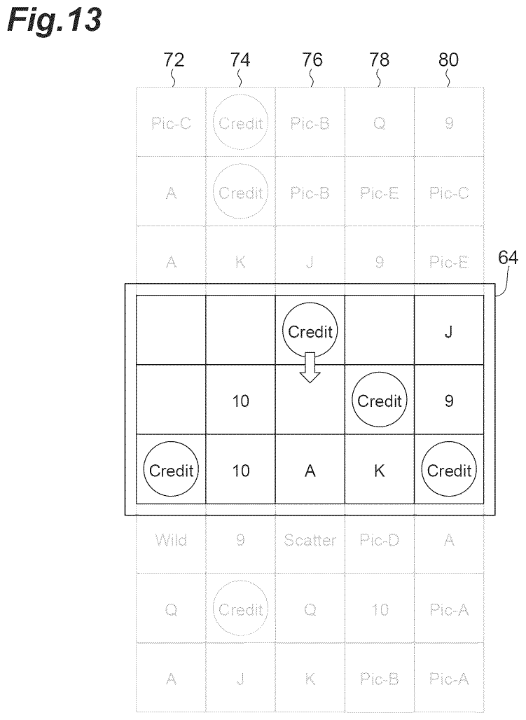

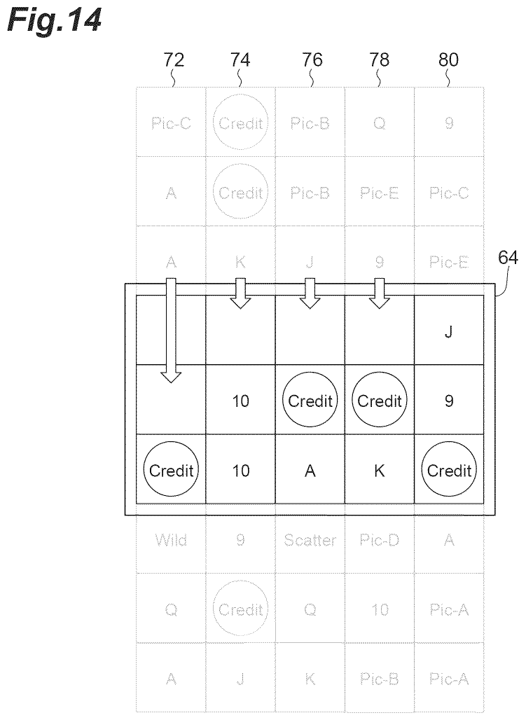

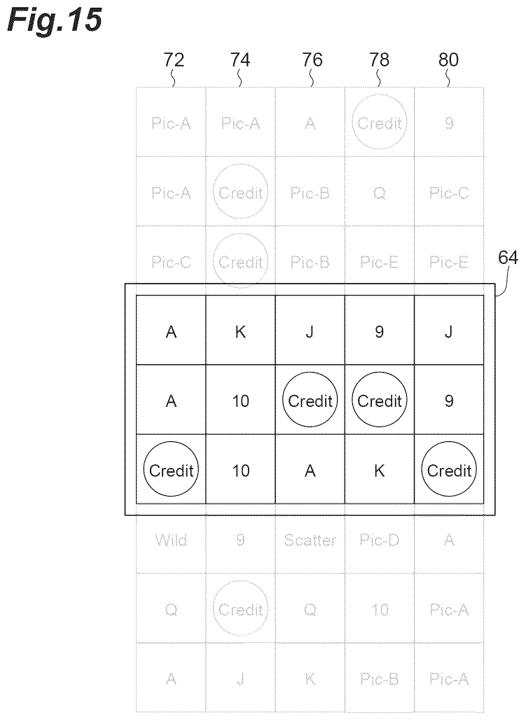

The control unit 22 then fills the blank cells with subsequent symbols following the removed specific symbols. As shown in FIGS. 13 and 14, the control unit 22 fills the blank cells by moving the subsequent symbols downward. FIG. 13 shows a state in which the subsequent symbol displayed on the symbol display area 64 moves downward. FIG. 14 shows a state in which subsequent symbols outside the area that are not displayed in the symbol display area 64 move into the area. The control unit 22 fills all blank cells as shown in FIG. 15 by moving subsequent symbols to display symbols in all cells in the symbol display area 64 of display 16.

In FIG. 15, the specific symbols do not exist in the symbol display area 64 of the display 16. Therefore, the control unit 22 does not perform the update processing of the symbol arrangements and finalizes the symbol arrangements of the symbol display area 64. In addition, since the credit symbol is not newly displayed, processing for paying out the total amount of the displayed credit symbol is not executed.

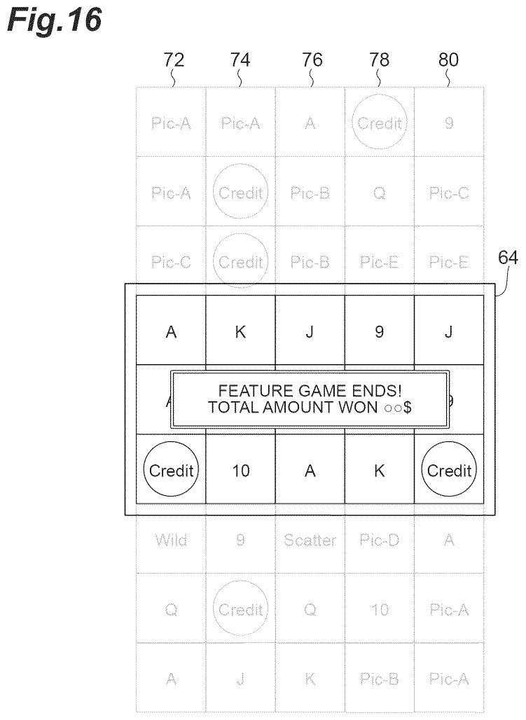

Finally, the control unit 22 displays a message notifying the player of the end of the feature game on the display 16 (see FIG. 16), and ends the feature game. The control unit 22 may display the total amount won in the feature game.

The control unit 22 may highlight the credit symbols and the specific symbols, and weaken the display by graying out or reducing the brightness of the other symbols. As a result, since only the symbols contributing to award are highlighted, the player can more intuitively understand the game.

The control unit 22 may determine symbols served as specific symbols or the types of symbols by a lottery using random numbers. In this case, since only the symbol “Pic-B” becomes the specific symbol in a certain feature game or the card symbol becomes the specific symbol in the next feature game, a feature game with a change can be provided. In another embodiment, all of the picture symbols may become the specific symbols when the control unit 22 determines those type of symbols served as the specific symbols.

The control unit 22 may remove the symbols displayed at the determined display positions (specific display positions) as specific symbols. The determined display positions are determined by a lottery using random numbers from among display positions other than the display positions displaying the credit symbols, for example. In this case, in a certain feature game, the symbol in the upper row regarding the virtual reel strip 72 becomes the specific symbol in a certain feature game, or the symbol in the lower row regarding the virtual reel strip 80 becomes the specific symbol in the next feature game, it is possible to provide a more varied feature game.

The control unit 22 performs the update process of symbol arrangements when the specific symbols are present in the symbol display area 64 of the display 16, but is not limited thereto. The control unit 22 may execute the update process in a case where the symbol arrangements formed on the display 16 by stopping a plurality of reels include specific symbols equal to or greater than a predetermined number, or may execute the update process in a case where the symbol arrangements include predetermined symbols, for example, scatter symbols. In this manner, the control unit 22 may remove specific symbols when symbol arrangements formed on the display 16 due to the plurality of reels stopping satisfy a predetermined condition. Alternatively, when the control unit 22 is determined by a lottery using random numbers, the specific symbols may be removed.

The control unit 22 may enlarge the symbol display area 64 described above at the beginning of the feature game. In the control unit 22, the symbol display area 64 is enlarged along the extending direction of the columns so that the number of symbols forming at least one column is increased in the symbol display area 64 in which symbols are displayed in a plurality of columns. That is, the symbol display area 64 is enlarged by enlarging the display area corresponding to the virtual reel strips 72 to 80 in the extending direction of the virtual reel strips. In the virtual reel strips 72 to 80, the display areas corresponding to some virtual reel strips may be enlarged, or the display areas corresponding to all virtual reel strips may be enlarged. The enlarged size of the display area may be different for each of the virtual reel strips 72 to 80 or may be the same for all the virtual reel strip 72 to 80. Since the probability that the credit symbol is newly displayed by the update processing of the symbol arrangements is increased by enlarging the symbol display area 64, the player can expect high award by the enlargement of the symbol display area 64.

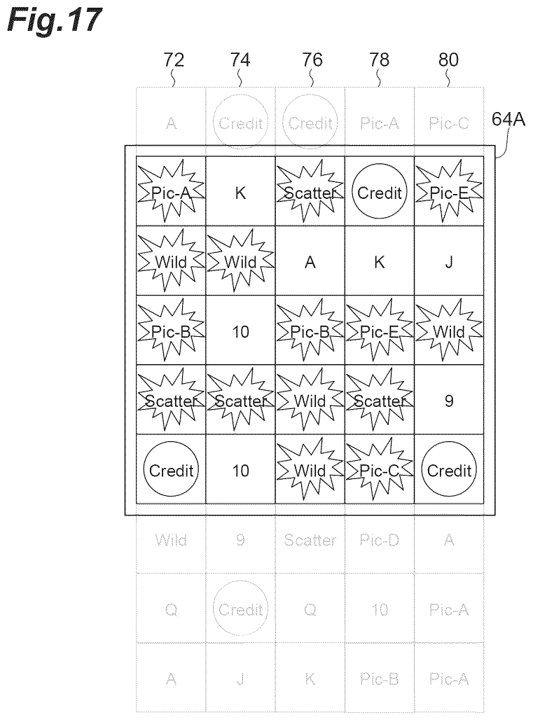

FIG. 17 shows an example in which the symbol display area 64 with 5×3 matrix is changed to the symbol display area 64A with 5×5 matrix. In FIG. 17, since the symbol display area 64 is enlarged, the credit symbol is newly displayed at the most upper row regarding the virtual reel strip 78. The control unit 22 may pay out the total amount of the displayed credit symbol even when the credit symbol is newly displayed due to the enlargement of the symbol display area 64. In this case, the player can intuitively understand the merit of the enlargement of the symbol display area 64, and can expect the payout process when the symbol display area 64 is enlarged, so that the player's interest can be further maintained or improved.

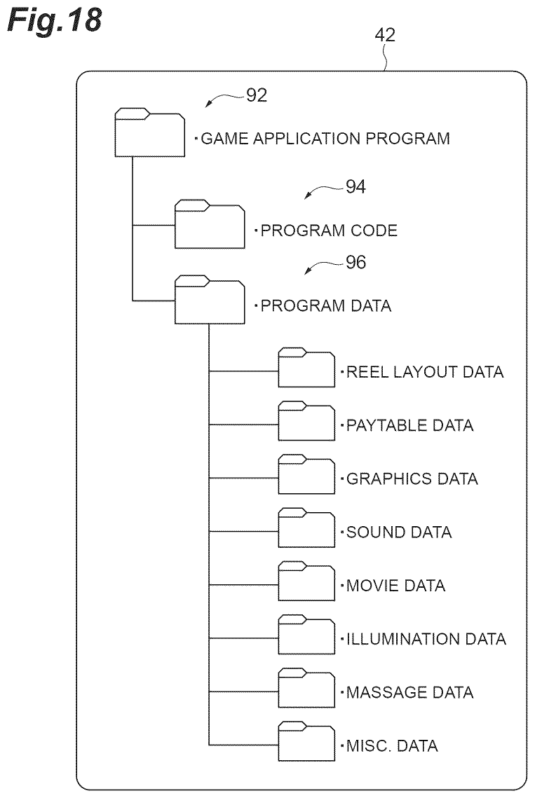

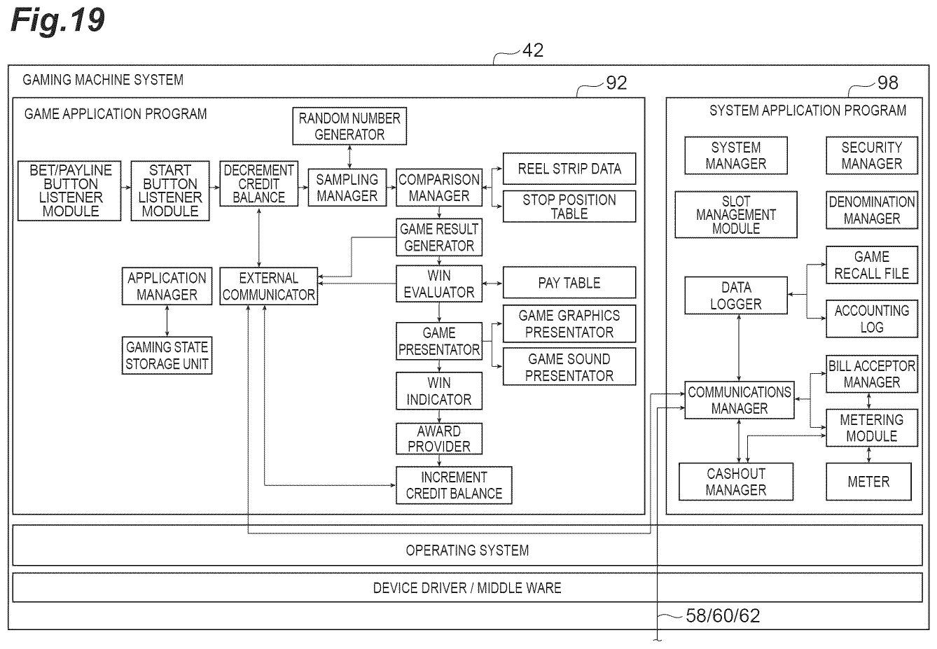

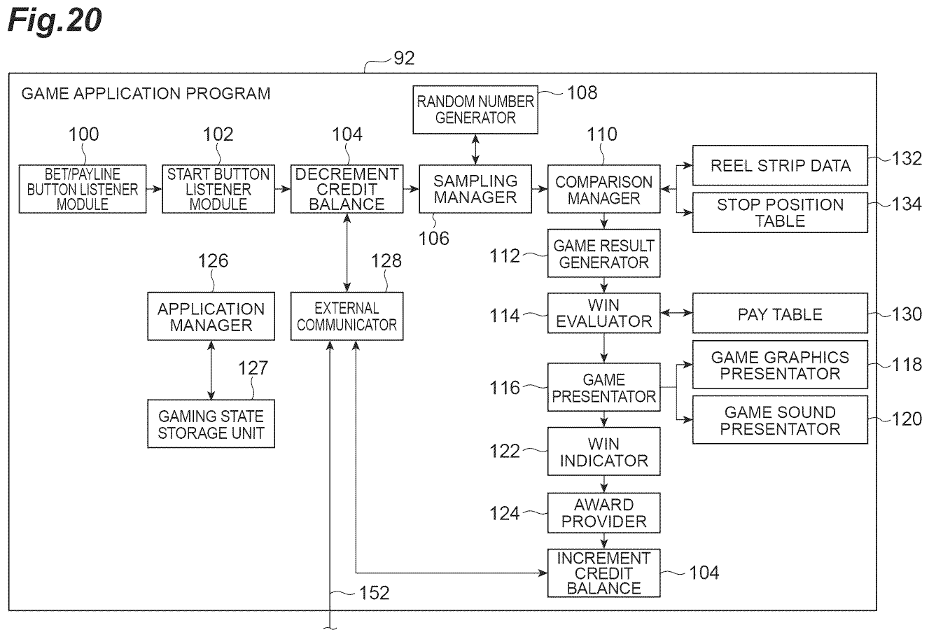

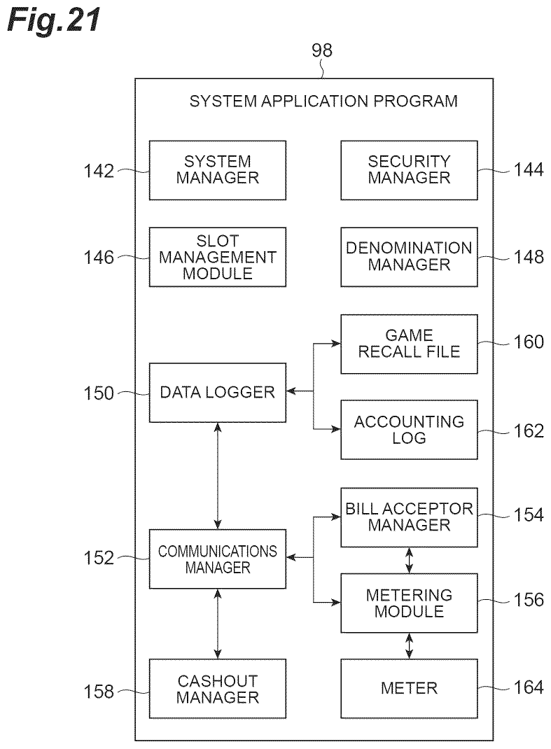

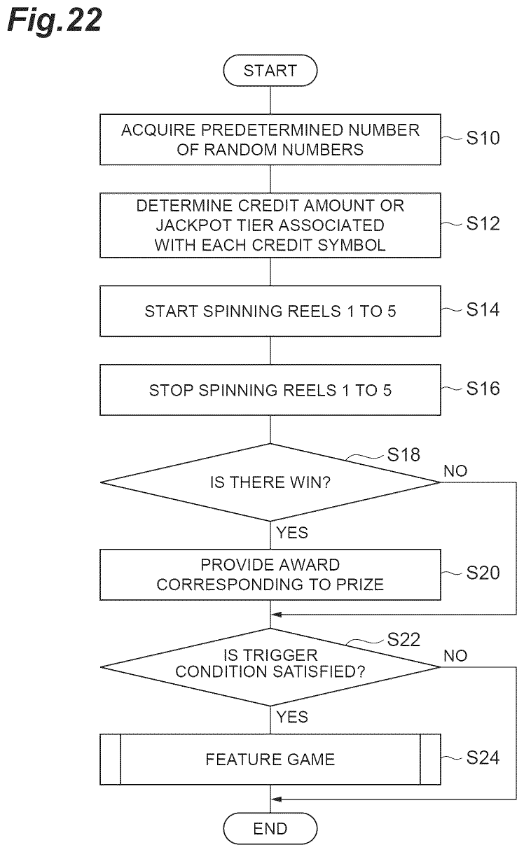

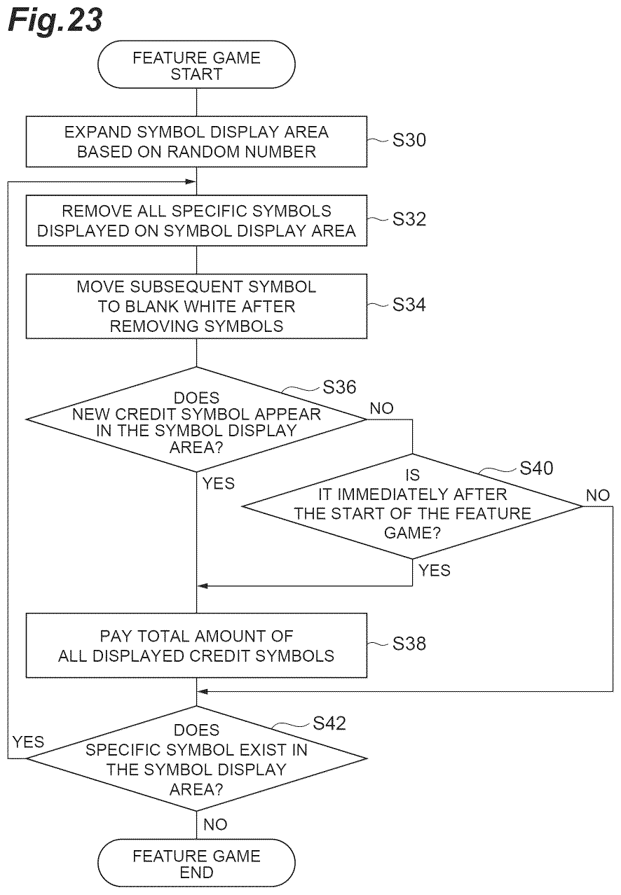

FIGS. 18 and 19 are a directory configuration diagram and a block diagram showing a program and data stored in the memory of FIG. 2. FIG. 20 is a block diagram of the game application program of FIG. 19. FIG. 21 is a block diagram of the system application program shown in FIG. 19. In the embodiments shown in FIGS. 18 to 21, the memory 42 stores a game application program 92 including computer-executable instructions, and processing of the game is performed by executing these computer-executable instructions in CPU 38, and the game screen is displayed on the display 16 in the gaming machine 10. Also, in one embodiment, the game application program 92 includes a program code 94 and a program object data 96 that includes computer-executable instructions for implementing a game using the algorithms shown in FIGS. 22 and 23.

In an exemplary embodiment, the memory 42 stores the game application program 92 and a system application program 98 including computer-executable instructions that are executed in the CPU 38 to process the game and display a game screen on the display 16 of the gaming machine 10. The game application program 92 provides a game specific/front-end function by executing on the CPU, and the system application program 98 provides a generic/back-end function. In the illustrated embodiment, the game application program 92 and the system application program 98 are implemented on the same operating system. However, it should be noted that these programs may be implemented on different operating system and/or by different processors.

In one embodiment, the game application program 92 includes a plurality of software modules including a bet/payline button listener module 100, a start button listener module 102, a credit balance manager module 104, a sampling manager 106, random number generator (RNG) 108, a comparison manager 110, a game result generator 112, a win evaluator 114, a game presentator 116, a game graphics presentator 118, a game sound presentator 120, a win indicator 122, an award provider 124, an application manager 126, and an external communicator 128. The game application program 92 may also include a pay table 130, a reel strip data 132, and a stop position table 134.

The bet/payline button listener module 100 is a software module for receiving a signal from a bet button 34 or a line-designation button 33 of the operation unit 32, the signal is generated by buttons when the player operates the buttons to select bet amount or the number of pay lines to activate. In response to receiving the signal, the bet/payline button listener module 100 communicates the occurrence of the signal to the application manager 126 for changing the configuration of the activated pay line or betting the game.

The start button listener module 102 is a software module for receiving a signal from a start button, which is generated when the player operates the button to start a game. In response to receiving the signal, the start button listener module 102 communicates the occurrence of the signal to the application manager 126 to initiate the game.

In response to receiving a signal from the start button listener module 102, the application manager 126 requests the sampling manager 106 to obtain the required number of random numbers from the random number generator 108.

The random number generator 108 is a software module for generating random numbers based on predetermined algorithm of computational random generation method. The random number generator 108 may be a pseudorandom generator. The random number generator 108 returns the random numbers in response to a request from the sampling manager 106. The random number generator 108 may be implemented in part or in whole as integrated circuits or wired logic.

The comparison manager 110 compares the current state of the game and/or each random number with the reel strip data 132 and the stop position table 134, and specifies the stopping position of the corresponding reel strip based on each random number.

The reel strip data 132 has virtual reel strips for normal games, free games, and special games. The comparison manager 110 described above queries the application manager 126 to identify the current state of the game and selects virtual reel strips.

The stop position table 134 includes a range of random numbers associated with each stopping position of the virtual reel strip. The comparison manager 110 determines the stopping position of each reel based on the corresponding random number and the stop position table 134.

The game result generator 112 generates a game result based on the selected reel layout, the stopping position of each reel, the stopping position of the inner symbol, and the attribute to be added. In one embodiment, the game result generator 112 may apply a modification on the game result when a predetermined condition is satisfied.

The win evaluator 114 evaluates the game result with reference to the pay table 130. To be specific, the winning evaluation is performed based on whether a symbol defined as a winning combination in the pay table 130 stops on a pay line set as a winning line in the symbol display area 64.

The game presentator 116 utilizes the game graphics presentator 118 and the game sound presentator 120 to provide a game presentation process consisting of video animation and sound to eventually form a predetermined game result.

The game sound presentator 120 provides a sound presentation process by using the sound controller 53 and speakers 26. The win indicator 122 indicates a winning combination and a payment condition of prize symbols formed in the game result. The award provider 124 provides award credit to the win meter based on the win evaluation.

The application manager 126 administrates the operation and state of each software module. In addition, the application manager 126 administrates the configuration, progress and states of the game application program 92. The application manager 126 refers to a gaming state storage unit 127, determines the size of the symbol display area 64 based on the stored game state, and provides the game. The external communicator 128 communicates instructions and data with the system application program 98.

The credit balance manager module 104 executes a process for decrementing the credit balance according to the bet amount and incrementing the credit balance based on the total amount of winnings displayed on the winning meter. The pay table 130 includes a payout amount or award amount associated with each winning combination.

In an exemplary embodiment, the system application program 98 provides back ground processing and functions other than game specific functions. The system application program 98 includes a plurality of software modules including a system manager 142, a security manager 144, a slot management module 146, a denomination manager 148, a data logger 150, a communications manager 152, a bill acceptor manager 154, a metering module 156, and a cashout manager 158.

The system application program 98 may include a game recall file 160, an accounting log 162, and a meter 164. The system manager 142 is a software module for administrating all of the back-ground processing and functions other than game specific functions conducted by the system application program 98.

The security manager 144 is a software module for administrating game verification, door security and monitoring security sensors. The slot management module 146 is a software module for administrating data accumulation and communicating with an external slot information system.

The denomination manager 148 is a software module for establishing the denomination setting of the gaming machine 10. The denomination setting may include 1 cent, 2 cents, 5 cents, 25 cents, 1 dollar, 5 dollars and the like. The data logger 150 is a software module for logging the results of each game in a game recall. In addition, the data logger 150 stores error events, bill logs, cashout logs, ticket logs, and the like in an accounting log.

The game recall file 160 is an accumulated data including the results of each game. The game recall file 160 is stored in non-volatile memory. The accounting log 162 is an accumulated data including error events, bill logs, cashout logs, ticket logs and the like. The accounting log 162 is stored in non-volatile memory.

The communications manager 152 is a software module for administrating communication between the game application program 92 and the system application program 98. The communications manager 152 also administrates network communications between the system application program 98 and other the gaming machine 10, external network such as slot management system network, G2S network, gaming server for server-based gaming network or VLT system network.

The bill acceptor manager 154 is a software module for managing bill acceptors, and accepts bill information inserted in the bill acceptor. In response to receiving the information from the bill acceptor, the bill acceptor manager 154 communicates with the metering module to increment the credit balance based on the inserted bill.

The metering module 156 is a software module for adjusting the value of the meter 164 in response to communication with the game application program 92 via the communications manager 152, the bill acceptor manager 154 or the cashout manager 158. The meter 164 includes a credit meter to indicate the current credit balance of the gaming machine and a win meter to indicate the total amount of wins for the current gaming session. The meter further includes background meters, such as coin-in, coin-out, total drop, attendant paid jackpot and/or bill-in. These meters may be implemented as a data on non-volatile memory or hardware meters.

The cashout manager 158 is a software module for administrating a cashout procedure. In response to the player's operation on the cashout button, the cashout manager 158 is activated and the gaming machine pays the total amount of credit meters in cash or a voucher.

FIGS. 22 and 23 are flowcharts for explaining the operation of the gaming machine. The algorithm (gaming method) of the operation of the gaming machine is implemented in the game application program 92 and is embodied by the CPU 38 executing the game application program 92. The operation of the gaming machine includes a plurality of steps. Each step may be performed independently or may be performed in combination with other steps.

In step S10, upon receiving a game start operation by the player and receiving an operation of the spin button from the player, the control unit 22 subtracts the set total bet amount from credit and acquires a predetermined number of random numbers required to provide the game. The random numbers are generated internally in the random number generator 108 in the control unit 22. The control unit 22 may acquire the random numbers from a random number generator provided separately from the control unit 22, or may acquire the random numbers from devices such as servers provided outside the gaming machine 10.

In step S12, the control unit 22 determines the credit amount or jackpot tier associated with each credit symbol. The control unit 22 determines the credit amount or jackpot tier based on the random number obtained in step S10. The jackpot tier is a level corresponding to the magnitude of the winning award, such as MINI, MAJOR, MAXI, or MEGA.

In steps S14 and S16, the control unit 22 starts and stops the spinning of the plurality of reels. As a result, a plurality of symbols is displayed on the symbol display area 64, the displayed symbols change, and a symbol combination is displayed on the symbol display area 64 as a game result.

In step S18, the control unit 22 determines whether the symbol combination displayed as the game result on the symbol display area 64 matches a winning combination. As an example, the control unit 22 determines a winning based on the symbol combination displayed in the symbol display area 64, the winning combination, and the set payline. When it is determined that there is a win (step S18: YES), the control unit 22 awards an amount corresponding to the prize as step S20. For example, the control unit 22 adds an amount corresponding to the win to the held credit.

When it is determined that there is no win (step S18: NO) or when the provision of awards (step S20) is completed, the control unit 22 determines whether the trigger condition is satisfied as step S22. For example, when the symbol combination displayed on the symbol display area 64 includes one or more credit symbols and the random number acquired in step S10 is within a predetermined range, it is determined that the trigger condition is satisfied. The control unit 22 may change the predetermined range of random numbers in accordance with the number of credit symbols displayed on the symbol display area 64. For example, the control unit 22 may expand the predetermined range of random numbers as the number of credit symbols displayed on the symbol display area 64 increases. Accordingly, the trigger condition is more likely to be satisfied as the number of displayed credit symbols is larger.

When it is determined that the trigger condition is satisfied (step S22: YES), the control unit 22 provides the feature game (step S24). When the provision of the feature game (step S24) is ended or when it is determined that the trigger condition is not satisfied (step S22: NO), the flowchart illustrated in FIG. 22 is ended.

As illustrated in step S30 of FIG. 23, when the feature game is started, the control unit 22 expands the symbol display area 64 based on the random number acquired in step S10.

Subsequently, in step S32, the control unit 22 removes all the specific symbols displayed on the symbol display area 64 of the display 16, and makes the cell displaying the specific symbols blank cell (blank white) (see FIG. 8). Next, in step S34, the control unit 22 moves the subsequent symbols of the specific symbols present in the area of the symbol display area 64 downward (see FIG. 9). Furthermore, the control unit 22 moves the subsequent symbols existing outside the area of the symbol display area 64 downward (see FIG. 10). As a result, all blank cells are filled as shown in FIG. 11, and symbols are displayed in all cells in the symbol display area 64 of the display 16.

Subsequently, in step S36, the control unit 22 determines whether a new credit symbol appears in the symbol display area 64 of the display 16. When it is determined that a new credit symbol has appeared (step S36: YES), the control unit 22 pays the total amount of all displayed credit symbols as step S38. When it is determined that the new credit symbol does not appear (step S36: NO), the control unit 22 determines whether it is immediately after the start of the feature game as step S40. When it is determined that it is immediately after the start of the feature game (step S40: YES), the control unit 22 pays the total amount of all displayed credit symbols as step S38. In this way, even if the credit symbol is not newly displayed, the total value of the credit symbols is paid only immediately after the trigger. Thus, the payment is guaranteed for the credit symbol when the trigger condition is satisfied. When the payment of the total amount of credit symbols (step S38) is completed, or when it is determined that it is not immediately after the start of the feature game (step S40: NO), the control unit 22 determines whether or not specific symbols exist in the symbol display area 64 of the display 16 as step S42. When it is determined that the specific symbols exist in the symbol display area 64 of the display 16 (step S42: YES), the process returns to step S32, and the processes of steps S32 to S40 are performed again. That is, the processes of steps S42 to S32 are repeated until no specific symbols newly occur in the symbol display area 64 of the display 16 by the determination process of step S40. When the specific symbols do not exist in the symbol display area 64 of the display 16 (step S42: NO), the feature game is ended.

As described above, in the gaming machine 10, since the process of changing the symbol arrangements is displayed by the stepwise animation in the feature game, the player can enjoy the process of generating the high payout. In addition, since the gaming machine 10 changes and updates symbols according to the arrangement of virtual reel strips even in the feature game, it is possible to give the player a sense of fairness that is not an arbitrary game result.

The gaming machine 10 may be client computing devices, in which case the game is delivered from a network-server computer system to one or more client computing devices via a communication network. The processor of the client computing devices may be programmed to function as the control unit 22 of the gaming machine 10.

When the gaming machine 10 is used as a client computing device, 1) a rich client system may be used in which most of the processing involved in game execution is performed on the client side and results are transmitted to the server, 2) a thin-client system may be used in which only minimum processing is performed on the client side and main processing is performed on the server side, and 3) a zero client system may be used in which most of data storage and processing is performed on the server side and client specializes in input and output. In this case, the software configuration described in the embodiment is implemented and implemented in the client and the server.

In the above-described embodiment, a case has been described in which the virtual reel strips 72 to 80 are associated with each column of cells of the grid 68, however, it is also possible to associate an independent reel with each of the cells. In the feature game in this case, for example, the same reel may be respun for the removed symbol positions, or the symbols may be removed together with the reel, the reel may be moved to an empty cell, and a spare reel may appear on a blank white. In the latter scenario, a new reel could appear from the outside of the symbol display area 64 in the blank cell at the end of the symbol display area 64.

The function of the control unit 22 of the gaming machine 10 described above can also be realized by executing a program by a computer. That is, it is possible to create a program that causes one or more computers to function in the same manner as the control unit 22 described above. The program may be provided by being recorded in a computer-readable recording medium such as a ROM or a semiconductor memory. Such a program may be divided into a plurality of modules.

Additionally, various modifications can be made to the operation in each embodiment. For instance, a mode could be adopted where a necessary number of random numbers are acquired in advance to determine the reel stop positions. Once the winning of the special game and the determination of the presence or absence of winning are completed, the contents are sequentially displayed on the display. Moreover, for instance, the control unit 22 could collectively acquire a necessary number of random numbers at the start of the game. Each random number could then be stored in a storage area of the memory 42 or the storage 44, which is not erased even when there is a power source anomaly. In this scenario, even if a power failure or similar event occurs during the game, the control unit 22 can reproduce the game's progress. This is done by acquiring the random number, which was obtained at the start of the game before the power failure, from the memory 42 or the storage 44 when resuming the game after power restoration. For instance, if a power supply abnormality occurs just before the formation of a game result in which a high payout is obtained, a problem could arise if the same game does not proceed after power restoration. However, by collectively acquiring all random numbers at the start of the game and storing these numbers in the memory 42 or the storage 44 as described above, it is possible to reproduce the game's progress similar to that before the power source abnormality occurred, after power recovery. This way, such a problem can be avoided.

Additionally, in the described embodiment, a bill or a ticket represents the game value. The bill or ticket is received by the bill/ticket identification unit, and the ticket is output by the printer unit. However, the present disclosure is not limited to this setup. The game value concept includes tangible objects like coins, bills, medals, or tickets, as well as electronic data such as virtual credits or virtual currencies with equivalent value. For instance, a coin acceptor could accept coins and dispense coins from a coin hopper. One mode could involve identifying a player and using credits accumulated in a server account, with credits being paid out to the account. Alternatively, a mode could be adopted where credit information recorded on a storage medium like a magnetic card or an IC card is read and used, with credits being paid out by writing the information back to the storage medium. Furthermore, credits could be electronically transferred to and from a smartphone or a wearable device.

What is claimed is:

1. A gaming machine comprising:
an operation unit configured to receive an operation of a player;
a display unit configured to partially display a plurality of reels each having a series of symbols including credit symbols, the credit symbols being associated with predetermined credit values; and
a control unit connected to the operation unit and the display unit, the control unit including a processor programmed to:
spin and stop the plurality of reels in response to operating the operation unit by the player; and
provide an award based on symbol arrangements formed on the display unit by the stopped plurality of reels,
wherein the processor is further programmed to:
remove all specific symbols from the display unit after stopping the plurality of reels to display the plurality of symbols on the display unit;
move subsequent symbols following the removed symbols with respect to a spin direction of the reel to fill positions of the removed symbols; and
provide an award based on the credit values associated with the credit symbols displayed on the display unit after moving the subsequent symbols.

2. The gaming machine according to claim 1, wherein when one or more specific symbols newly occur after moving the subsequent symbols, the processor is further programmed to repeat removal of the specific symbols and movement of the subsequent symbols until no specific symbols newly occur on the display unit and provide an award based on the credit values associated with the credit symbols displayed on the display unit upon occurrence of new credit symbol while repeating the removal and the movement.

3. The gaming machine according to claim 1, wherein each of the specific symbols is a symbol having a specific type.

4. The gaming machine according to claim 1, wherein the processor is further programmed to determine the specific symbols or types of symbols served as the specific symbols by a lottery using random numbers.

5. The gaming machine according to claim 1, wherein the processor is further programmed to determine one or more specific display positions other than display positions at which the credit symbols are displayed, by a lottery using random numbers, remove symbols displayed at the specific display positions as the specific symbols, and move the subsequent symbols following the removed symbols in the spin direction of the reel to display positions vacated by the removal of the symbols to fill the positions of the removed symbols.

6. The gaming machine according to claim 1, wherein the processor is further programmed to remove the specific symbols when symbol arrangements formed on the display unit satisfy a predetermined condition after the plurality of reels are stopped.

7. The gaming machine according to claim 1, wherein the processor is further programmed to remove the specific symbols by a lottery using random numbers.

8. The gaming machine according to claim 1, wherein the processor is further programmed to enlarge a display area for displaying symbols after the plurality of reels are stopped and symbol arrangements are formed in the display unit, display symbols in the enlarged display area based on the reels, and perform removal and movement of the specific symbols for the symbols displayed in the enlarged display area.

9. A method of providing a game on a gaming machine, the gaming machine comprising an operation unit configured to receive an operation of a player, a display unit configured to partially display a plurality of reels each having a series of symbols including credit symbols, the credit symbols being associated with predetermined credit values, and a control unit connected to the operation unit and the display unit, wherein the control unit includes a processor programmed to spin and stop the plurality of reels in response to the operation of the operation unit by the player and provide an award based on symbol arrangements formed on the display unit by the stopped plurality of reels, the method comprising:
spinning the plurality of reels in response to a player's operation of the operation unit;
stopping rotation of the plurality of reels and displaying a plurality of symbols on the display unit;
removing all specific symbols from the display unit;
moving subsequent symbols following the removed symbols with respect to a spin direction of the reel to fill positions of the removed symbols; and
providing an award based on the credit values associated with the credit symbols displayed on the display unit after moving the subsequent symbols.

10. A non-transitory computer-readable storage medium storing a program to be executed by a computer, the computer comprising an operation unit configured to receive an operation of a player, a display unit configured to partially display a plurality of reels each having a series of symbols including credit symbols, the credit symbols being associated with predetermined credit values, and a control unit connected to the operation unit and the display unit, wherein the control unit includes a processor programmed to spin and stop the plurality of reels in response to the operation of the operation unit by the player and provide an award based on symbol arrangements formed on the display unit by the stopped plurality of reels, the program causing the processor to:
spin the plurality of reels in response to a player's operation of the operation unit;
stop rotation of the plurality of reels and displaying a plurality of symbols on the display unit;
remove all specific symbols from the display unit;
move subsequent symbols following the removed symbols with respect to a spin direction of the reel to fill positions of the removed symbols; and
provide an award based on the credit values associated with the credit symbols displayed on the display unit after moving the subsequent symbols.
